(19) United States
(12) Patent Application Publication
(10) Pub. No.: US 2022/0045319 A1
(43) Pub. Date: Feb. 10, 2022

(54) SECONDARY BATTERY POSITIVE ELECTRODE ACTIVE MATERIAL AND SECONDARY BATTERY

(71) Applicant: Panasonic Intellectual Property Management Co., Ltd., Osaka-shi, Osaka (JP)

(72) Inventors: Hiroyuki Matsumoto, Osaka (JP); Nobuhiko Hojo, Osaka (JP); Atsushi Fukui, Hyogo (JP)

(73) Assignee: Panasonic Intellectual Property Management Co., Ltd., Osaka-shi, Osaka (JP)

(21) Appl. No.: 17/275,475

(22) PCT Filed: Jul. 26, 2019
(86) PCT No.: PCT/JP2019/029398

§ 371 Date: Mar. 11, 2021

(30) Foreign Application Priority Data
Sep. 27, 2018 (JP) 2018-181202

(51) Int. Cl. H01M 4/505; H01M 4/36

(52) U.S. Cl. CPC H01M 4/505; H01M 2004/028; H01M 4/366

(57) ABSTRACT

A positive electrode active material that is represented by the general formula LiₓM_{1-y}L_{y}O₂ (wherein 0.9≤x≤1.1, 0≤y<0.6, the element M is at least one element selected from the group that consists of Ni and Co, and the element L is at least one element selected from the group that consists of alkali earth elements, transition metal elements other than Ni and Co, rare earth elements, group IIIB elements, and group IVB elements). A surface layer part of the positive electrode active material includes an oxide of an element Me that is at least one element selected from the group that consists of B, Si, P, Ti, V, Mn, Al, Mg, Ca, Zr, W, Nb, Ta, In, Mo, and Sn.

### TECHNICAL FIELD

The present disclosure relates to a positive electrode active material for a secondary battery and a secondary battery.

### BACKGROUND ART

Aqueous lithium secondary batteries using an aqueous solution as an electrolytic solution are known. Aqueous lithium secondary batteries need to be used in an electric potential range in which the electrolytic reaction of water does not occur. An active material needs to be used that is stable in an aqueous solution and can reversibly occlude and release a large amount of lithium in a potential range in which oxygen or hydrogen is not generated by water electrolysis, namely an active material that can exhibit large capacity in a specific potential range. It has been desired to use a neutral or alkaline electrolytic solution as an electrolytic solution. When a neutral electrolytic solution, namely an electrolytic solution of pH=7, is used, the hydrogen generating potential is 2.62 V and the oxygen generating potential is 3.85 V for the water decomposition voltage. When a strong alkaline electrolytic solution, namely an electrolytic solution of pH=14 is used, the hydrogen generating potential is 2.21 V and the oxygen generating potential is 3.44 V for the water decomposition voltage.

Therefore, a material from which more Li can be extracted before or when the potential reaches at least 3.85 V (pH=7) has been desired as a positive electrode active material. A material in which more Li can be inserted before or when the potential reaches 2.21 V (pH=14) has been desired as a negative electrode active material.

Patent Literature 1 discloses that a positive electrode active material for aqueous lithium secondary batteries has a compound having a layered structure and represented by the general formula LiₛNiₓCo_{y}Mn_{z}MₜO₂ (0.9≤s≤1.2, 0.25≤x≤0.4, 0.25≤y≤0.4, 0.25≤z≤0.4, 0≤t≤0.25, and M is one or more selected from Mg, Al, Fe, Ti, Ga, Cu, V, and Nb) as the main ingredient.

### CITATION LIST

### Patent Literature

PATENT LITERATURE 1: Japanese Patent No. 4581524

### SUMMARY

In secondary batteries using aqueous solutions, technology has been required that enables expanding a potential region in which electrolysis does not occur and improving the durability thereof, namely suppressing a capacity decrease and battery deterioration at the time of charge and storage.

It is an advantage of the present disclosure to provide a positive electrode active material for a secondary battery and a secondary battery in which a capacity decrease and battery deterioration at the time of charge and storage are suppressed in the positive electrode active material for a secondary battery using an aqueous electrolytic solution and the secondary battery using an aqueous electrolytic solution.

The positive electrode active material according to one aspect of the present disclosure is a positive electrode active material for a secondary battery having an electrolytic solution prepared by dissolving a lithium salt in water, including: a lithium transition metal oxide represented by the general formula LiₓM_{1-y}L_{y}O₂, wherein 0.9≤x≤1.1, 0≤y≤0.6, an element M is at least one selected from the group consisting of Ni and Co, and an element L is at least one selected from the group consisting of alkaline-earth elements, transition metal elements other than Ni and Co, rare earth elements, Group IIIb elements, and Group IVb elements. The positive electrode active material is a complex oxide having an oxide of an element Me, which is at least one selected from the group consisting of B, Si, P, Ti, V, Mn, Al, Mg, Ca, Zr, W, Nb, Ta, In, Mo, and Sn, in an outer layer portion of the lithium transition metal oxide.

According to the present disclosure, a capacity decrease and battery deterioration at the time of charge and storage may be suppressed.

### BRIEF DESCRIPTION OF DRAWING

FIG. 1 is an operation explanatory diagram of an embodiment.

FIG. 2 is a schematic diagram of a positive electrode active material of an embodiment.

### DESCRIPTION OF EMBODIMENTS

The present inventors have earnestly examined and consequently found that the use of a specific material as a positive electrode active material in an electrolytic solution containing water as a solvent and a lithium salt as an electrolyte salt enables suppressing the deterioration of a battery at the time of charge and storage.

Embodiments of the positive electrode active material and the secondary battery according to one aspect of the present disclosure will be described hereinafter. However, the embodiments described below is examples, and the present disclosure is not limited to these.

[Aqueous Electrolytic Solution]

An aqueous electrolytic solution according to the present embodiment includes at least water and a lithium salt. When an electrolytic solution containing water as a solvent is used, water decomposes at a voltage of 1.23 V theoretically. Therefore, the development of a secondary battery in which even though higher voltage is impressed, water does not decompose and which operates steadily has also been desired.

(Solvent)

The aqueous electrolytic solution contains water as the main solvent. Here, containing water as the main solvent means that the volume ratio of the water content to the total volume of solvents included in the electrolytic solution is 50% or more. The content of water included in the electrolytic solution is preferably 90% or more based on the total amount of the solvents in terms of the volume ratio. The solvent included in the electrolytic solution may be a mixed solvent including water and a non-aqueous solvent. Examples of the non-aqueous solvent include alcohols such as methanol; carbonates such as dimethyl carbonate, ethyl methyl carbonate, diethyl carbonate, ethylene carbonate, and propylene carbonate; acetone; acetonitrile; and aprotic polar solvents such as dimethyl sulfoxide.

Since the aqueous electrolytic solution includes water, which does not have inflammability, as the main solvent, the safety of the secondary battery using the aqueous electrolytic solution can be enhanced. The content of water is preferably 8% by mass or more, and more preferably 10% by mass or more based on the total amount of the electrolytic solution from this viewpoint. The content of water is preferably 50% by mass or less, and more preferably 20% by mass or less based on the total amount of the electrolytic solution.

(Lithium Salt)

As long as a lithium salt included in the aqueous electrolytic solution is a compound which is dissolved in the solvent containing water, dissociates, and enables lithium ions to be present in the aqueous electrolytic solution, any lithium salt can be used. The lithium salt does not preferably deteriorate battery characteristics by reaction with materials constituting a positive electrode and a negative electrode. Examples of such a lithium salt include salts with inorganic acids such as perchloric acid, sulfuric acid, and nitric acid; salts with halide ions such as chloride ions and bromide ions; and salts with organic anions including carbon atoms in structure.

Examples of the organic anions constituting lithium salts include anions represented by the following general formulae (i) to (iii).

(R¹SO₂)(R²SO₂)N⁻ (i)

wherein R¹ and R² are each independently selected from halogen atoms, alkyl groups, or halogen-substituted alkyl groups, and R¹ and R² may be bonded to each other to form a ring.

R³SO₃⁻ (ii)

wherein R³ is selected from halogen atoms, alkyl groups, or halogen-substituted alkyl groups.

R⁴CO₂⁻ (iii)

wherein R⁴ is selected from alkyl groups or halogen-substituted alkyl groups.

In the above-mentioned general formulae (i) to (iii), the alkyl group or the halogen-substituted alkyl group has preferably 1 to 6 carbon atoms, more preferably 1 to 3 carbon atoms, and further preferably 1 to 2 carbon atoms. As the halogen of the halogen-substituted alkyl group is preferably fluorine. The number of halogen atoms substituted in the halogen-substituted alkyl group is not more than the number of the hydrogen atoms of the original alkyl group. As halogen atoms in the above-mentioned general formulae (i) to (ii), a fluorine atom is preferable.

When each of R¹ to R⁴ is, for example, a saturated alkyl group or a saturated halogen-substituted alkyl group, and R¹ to R² are not bonded to each other not to form a ring, each of R¹ to R⁴ may be a group represented by the following general formula (iv).

CₙHₐF_{b}Cl_{c}Br_{d}Iₑ (iv)

wherein n is an integer of 1 or more, and a, b, c, d, and e are integers of 0 or more, and satisfy 2n+1=a+b+c+d+e.

In the above-mentioned general formula (iv), a is preferably smaller, a=0 is more preferable, and 2n+1=b is the most preferable from the viewpoint of oxidation resistance.

Specific examples of the organic anion represented by the above-mentioned general formula (i) include bis(fluorosulfonyl)imide (FSI; [N(FSO₂)₂]⁻), bis(trifluoromethanesulfonyl)imide (TFSI; [N(CF₃SO₂)₂]⁻), bis(perfluoroethanesulfonyl)imide (BETI; [N(C₂F₅SO₂)₂]⁻), and (perfluoroethanesulfonyl)(trifluoromethanesulfonyl)imide ([N(C₂F₅SO₂)(CF₃SO₂)]⁺). Specific examples of the organic anion formed by binding R¹ to R² to each other to formula ring include cTFSI; ([N(CF₂SO₂)₂]⁻). Specific examples of the organic anion represented by the above-mentioned general formula (ii) include FSO₃⁻, CF₃SO₃⁻, and C₂F₅SO₃⁻. Specific examples of the organic anion represented by the above-mentioned general formula (iii) include CF₃CO₂⁻ and C₂F₅CO₂⁻.

Examples of an organic anion other than the above-mentioned general formula (i) include anions such as bis(1,2-benzenediolate(2-)-O,O′)borate, bis(2,3-naphthalenediolate(2-)-O,O′)borate, bis(2,2′-biphenyldiolate(2-)-O,O)borate, and bis(5-fluoro-2-olate-1-benzenesulfonate-O,O′)borate.

As an anion constituting a lithium salt, an imide anion is preferable. Suitable specific examples of the imide anion include (fluorosulfonyl)(trifluoromethanesulfonyl)imide (FTI; [N(FSO₂)(CF₃SO₂)]⁻) besides an imide anion illustrated as the organic anion represented by the above-mentioned general formula (i).

Specific examples of the lithium salt having a lithium ion and an imide anion include lithium bis(trifluoromethanesulfonyl)imide (LiTFSI), lithium bis(perfluoroethanesulfonyl)imide (LiBETI), lithium (perfluoroethanesulfonyl)(trifluoromethanesulfonyl)imide, lithium bis(fluorosulfonyl)imide (LiFSI), and lithium (fluorosulfonyl)(trifluoromethanesulfonyl)imide (LiFTI).

Specific examples of other lithium salts include CF₃SO₃Li, C₂F₅SO₃Li, CF₃CO₂Li, C₂F₅CO₂Li, lithium bis(1,2-benzenediolate(2+O,O′)borate, lithium bis(2,3-naphthalenediolate(2-)-O,O′)borate, lithiums bis(2,2′-biphenyldiolate(2-)-O,O)borate, lithium bis(5-fluoro-2-olate-1-benzenesulfonate-O,O′)borate, lithium perchlorate (LiClO₄), lithium chloride (LiCl), lithium bromide (LiBr), lithium hydroxide (LiOH), lithium nitrate (LiNO₃), lithium sulfate (Li₂SO₄), lithium sulfide (Li₂S), and lithium hydroxide (LiOH).

In the aqueous electrolytic solution according to the present embodiment, the content ratio of water to the lithium salt is preferably a molar ratio of 15:1 or less, and more preferably 4:1 or less. It is because when the content ratio of water to the lithium salt is in these ranges, the potential window of the aqueous electrolytic solution can be expanded, and voltage impressed on the secondary battery can be further increased. The content ratio of water to the lithium salt is preferably a molar ratio of 1.5:1 or more from the viewpoint of the safety of the secondary battery.

(Additive)

The aqueous electrolytic solution according to the present embodiment may further include additives and other electrolytes known in the art. As the other electrolytes, a lithium ion conductive solid electrolyte may further be included.

Examples of the additives include fluorophosphoates, carboxylic acid anhydrides, alkaline-earth metal salts, sulfur compounds, acids, and alkalis. The aqueous electrolytic solution preferably further include at least one of the group consisting of fluorophosphates, carboxylic acid anhydrides, alkaline-earth metal salts, and sulfur compounds. The content of these additives is, for example, 0.1% by mass or more and 5.0% by mass or less based on the total amount of the aqueous electrolytic solution.

Examples of the fluorophosphates which may be added to the aqueous electrolytic solution include lithium fluorophosphates represented by the general formula LixPFyOz (1≤x≤3, 0≤y≤2, 2≤z≤4). When the aqueous electrolytic solution contains a fluorophosphate, the electrolysis of water can be suppressed. Specific examples of the lithium fluorophosphate include lithium difluorophosphates (LiPF₂O₇) and lithium monofluorophosphates (Li₂PFO₃), and LiPF₂O₂ is preferable. The fluorophosphate represented by the general formula LixPFyOz may be a mixture of two or more selected from LiPF₂O₂, Li₇PFO₃, and Li₃PO₄. In that case, x, y, and z may be numerical values other than integers. The content of the fluorophosphate may be, for example, 0.1% by mass or more, and is preferably 0.3% by mass or more based on the total amount of the aqueous electrolytic solution. The content of the lithium fluorophosphate may be, for example, 3.0% by mass or less, and is preferably 2.0% by mass or less based on the total amount of an aqueous electrolytic solution.

An alkaline-earth metal salt which may be added to the aqueous electrolytic solution is a salt having an ion of an alkaline-earth metal (Group 2 element) and an anion such as an organic anion. Examples of the alkaline-earth metal include beryllium (Be), magnesium (Mg), calcium (Ca), and strontium (Sr), and magnesium and calcium are preferable.

Examples of the organic anion constituting the alkaline-earth metal salt include organic anions described as the above-mentioned organic anions constituting lithium salts and represented by the general formulae (i) to (iii). However, the anion constituting the alkaline-earth metal salt may be an organic anion other than the organic anions represented by the general formulae (i) to (iii), or may be an inorganic anion.

The dissociation constant of the alkaline-earth metal salt in the aqueous electrolytic solution is preferably large. Suitable examples thereof include alkaline-earth-metal salts of perfluoroalkanesulfonic imides such as Ca[N(CF₃SO₃)₂]₂ (CaTFSI), Ca[N(CF₃CF₃SO₂)₂]₂ (CaBETI), Mg[N(CF₃SO₃)₂]₂. (MgTFSI) and Mg[N(CF₃CF₃SO₂)₂]₂ (MgBETI); alkaline-earth metal salts of trifluoromethanesulfonic acid such as Ca(CF₃SO₃)₂ and Mg(CF₃SO₃)₂; alkaline-earth metal perchlorates such as Ca[ClO₄]₂ and Mg[ClO₄]₂; and tetrafluoroborates such as Ca[BF₄]₂ and Mg[BF₄]₂. Among these, alkaline-earth metal salts of perfluoroalkanesulfonic imides are further preferable, and CaTFSI and CaBETI are particularly preferable from the viewpoint of plastic action. As the alkaline-earth metal salts, alkaline-earth metal salts having the same anion as the Li salts included in the electrolytic solution are also preferable. The alkaline-earth metal salts may be used alone, or may be used in combination of two or more. The content of the alkaline-earth metal salt may be, for example, 0.5% by mass or more and 3% by mass or less, and is preferably 1.0% by mass or more and 2% by mass or less based on the total amount of the aqueous electrolytic solution from the viewpoint of the expansion of the potential window to the base potential side.

The carboxylic acid anhydrides which may be added to the aqueous electrolytic solution includes a cyclic carboxylic acid anhydride and a chain-like carboxylic acid anhydride. Examples of the cyclic carboxylic acid anhydride include succinic anhydride, glutaric anhydride, maleic anhydride, citraconic anhydride, glutaconic anhydride, itaconic anhydride, diglycollic anhydride, cyclohexanedicarboxylic acid anhydride, cyclopentanetetracarboxylic acid anhydride, and phenylsuccinic anhydride. The chain-like carboxylic acid anhydride is an anhydride of two carboxylic acids which are selected from carboxylic acids such as acetic acid, propionic acid, butyric acid, and isobutyric acid having 1 to 12 carbon atoms, and are the same or is different. Specific examples thereof include acetic anhydride and propionic anhydride. When the carboxylic acid anhydride is added to the aqueous electrolytic solution, the carboxylic acid anhydride may be used alone or in combination of two or more. The content of the carboxylic acid anhydride may be, for example, 0.1% by mass or more and 5.0% by mass or less, and is preferably 0.3% by mass or more and 2.0% by mass or less based on the total amount of the aqueous electrolytic solution.

Examples of a sulfur compound which may be added to the aqueous electrolytic solution include organic compounds containing a sulfur atom in a molecule and included in neither the above-mentioned lithium salts, carboxylic acids nor alkaline-earth metal salts. When the aqueous electrolytic solution contains the sulfur compound, components contained in a film derived from the reduction reaction of anions such as TFSI and BETI represented by the general formulae (i) to (iii) can be compensated, and hydrogen generation which proceeds parasitically on a negative electrode can be shut off effectively. Specific examples of the sulfur compound include cyclic sulfur compounds such as ethylene sulfite, 1,3-propanesultone, 1,4-butanesultone, sulfolane, and sulfolene; sulfonic esters such as methyl methanesulfonate and busulfan; sulfones such as dimethyl sulfone, diphenyl sulfone, and methyl phenyl sulfone; sulfides or disulfides such as dibutyl disulfide, dicyclohexyl disulfide, and tetramethyl thiuram monosulfide; and sulfonamides such as N,N-dimethylmethanesulfonamide and N,N-diethylmethanesulfonamide. Among these sulfur compounds, ethylene sulfite, 1,3-propanesultone, 1,4-butanesultone, sulfolane, sulfolene, and the like are preferable, and ethylene sulfite is particularly preferable. When the sulfur compound is added to the aqueous electrolytic solution, the sulfur compound may be used alone or in combination of two or more. The content of the sulfur compound may be, for example, 0.1% by mass or more and 5.0% by mass or less, and is preferably 0.3% by mass or more and 2.0% by mass or less based on the total amount of the aqueous electrolytic solution.

The method for preparing the aqueous electrolytic solution according to the present embodiment is not particularly limited, for example, water and the lithium salt as well as the above-mentioned additives, if the additives are added, may be suitably mixed to prepare the aqueous electrolytic solution.

Although the pH of the aqueous electrolytic solution is not particularly limited, the pH may be, for example, 3 or more and 14 or less, and is preferably more than 10. It is because when the pH of the aqueous electrolytic solution is in these ranges, the stability of the positive electrode active material in the positive electrode and the negative electrode active material in the negative electrode in the aqueous solution can be improved, and the occlusion and release reactions of lithium ions in the positive electrode active material and the negative electrode active material are performed more smoothly.

[Secondary Battery]

A secondary battery according to an example of embodiments of the present disclosure will be described hereinafter. The secondary battery which is an example of the embodiments comprises the above-mentioned aqueous electrolytic solution, a positive electrode, and a negative electrode. The secondary battery has, for example, a structure in which an electrode assembly having the positive electrode, the negative electrode, and a separator and the aqueous electrolytic solution are stored in a battery case. Although examples of the electrode assembly include a wound electrode assembly, which is formed by winding the positive electrode and the negative electrode through the separator and a laminated electrode assembly, which is formed by laminating the positive electrode and the negative electrode through the separator, the shape of the electrode assembly is not limited to these.

Examples of the battery case which stores the electrode assembly and the aqueous electrolytic solution include cases made of metals or resins in a cylindrical shape, a square shape, a coin shape, a button shape, and the like and cases made of resins and obtained by molding a sheet in which metal foil and a resin sheet are laminated (laminated battery).

The secondary battery according to the present embodiment may be manufactured by a well-known method, and can be manufactured, for example, by storing the wound or laminated electrode assembly in the battery case body, pouring the aqueous electrolytic solution and then sealing the opening of the battery case body with a gasket and a sealing assembly.

[Positive Electrode]

The positive electrode constituting the secondary battery according to the present embodiment comprises, for example, a positive electrode current collector and a positive electrode active material layer formed on the positive electrode current collector. The positive electrode active material layer may be formed on one side of the positive electrode current collector, or may be formed on both sides. The positive electrode active material layer includes, for example, the positive electrode active material, a binding agent, a conductive agent, and the like.

As the positive electrode current collector, foil of a metal which is stable in the potential range of the positive electrode, a film wherein the metal is disposed on the outer layer, or the like can be used. As the positive electrode current collector, a porous body such as a mesh body, a punching sheet, or an expanded metal of the metal may be used. As the material of the positive electrode current collector, stainless steel, aluminum, an aluminum alloy, titanium, or the like can be used. The thickness of the positive electrode current collector is, for example, preferably 3 μm or more and 50 μm or less in terms of a current collection property, mechanical strength, and the like.

For example, positive electrode mixture slurry including the positive electrode active material, the conductive agent, the binding agent, and the like is applied to the positive electrode current collector and dried to form the positive electrode active material layer on the positive electrode current collector, and the positive electrode active material layer is rolled to obtain the positive electrode. As dispersion medium used for the positive electrode mixture slurry, for example, water; an alcohol such as ethanol; an ether such as tetrahydrofuran; N-methyl-2-pyrrolidone (NMP); or the like is used. Although the thickness of the positive electrode active material layer is not particularly limited, the thickness is, for example, 10 μm or more and 100 μm or less.

The positive electrode active material includes a lithium transition metal oxide containing lithium (Li) and transition metal elements such as cobalt (Co), manganese (Mn), and nickel (Ni). A specific example of the lithium transition metal oxide is represented by LiₓM_{1-y}L_{y}O₂. As to x, it is preferable that 0.9≤x≤1.1, and it is further preferable that 0.95≤x≤1.02. As to y, it is preferable that 0≤y<0.6 in view of the stability of the crystal structure. An element M is at least one selected from the group consisting of nickel (Ni) and cobalt (Co). An element L is at least one selected from the group consisting of alkaline-earth elements, transition metal elements other than Ni and Co, rare earth elements, Group Mb elements, and Group IVb elements.

The lithium transition metal oxide contains preferably 40% by mol or more Ni, and further preferably 90% by mol or more Ni based on the total amount of transition metals other than lithium in view of increasing the capacity.

The positive electrode active material is a complex oxide having an oxide of an element Me, which is at least one selected from the group consisting of boron (B), silicon (Si), phosphorus (P), titanium (Ti), vanadium (V), manganese (Mn), aluminum (Al), magnesium (Mg), calcium (Ca), zirconium (Zr), tungsten (W), niobium (Nb), tantalum (Ta), indium (In), molybdenum (Mo), and tin (Sn), in an outer layer portion of the lithium transition metal oxide.

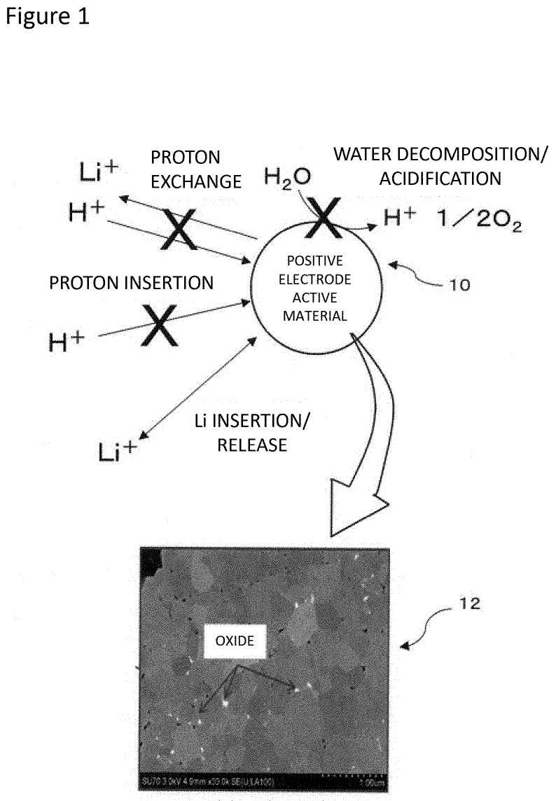

FIG. 1 shows an explanatory diagram of a positive electrode active material 10 according to the present embodiment. In a secondary battery using an aqueous electrolytic solution, the capacity decreases due to self-discharge by proton insertion into the positive electrode active material 10 from an electrolytic solution. The capacity especially when the positive electrode active material having a high nickel ratio is used can decrease. The capacity can also decrease by the exchange between protons and Li ions (proton exchange). Additionally, the capacity can also decrease due to the oxidative decomposition of water and the acidification of the electrolytic solution accompanying this. Meanwhile, when an oxide of, for example, W or the like is present in the outer layer portion of the positive electrode active material, proton insertion, proton exchange, and the oxidative decomposition of water are suppressed with the oxide, and a capacity decrease and a voltage decrease are suppressed thereby.

FIG. 1 also shows a sectional SEM image 12 of an outer layer portion of the positive electrode active material 10 through a scanning electron microscope (SEM) collectively. The positive electrode is embedded into a resin, and a section of the particles is prepared by cross section polisher (CP) processing or the like, and the sectional SEM image 12 can be obtained by photographing this section through the SEM. The sectional SEM image 12 shows that the oxide is present in the outer layer portion of the positive electrode active material. When the positive electrode active material 10 contains primary particles and secondary particles formed by aggregation of primary particles, it is preferable that the oxide is present in the outer layer portions of the secondary particles, and also present in the outer layer portions of the primary particles. When the oxide is present not only in the outer layer portions of the secondary particles but also in the outer layer portions of the primary particles, proton insertion, proton exchange, and the like can be suppressed surely.

It is preferable that the element Me present in the outer layer portions of the lithium transition metal oxide particles deposits on the surface of the lithium transition metal oxide, adheres to the surface, or is carried on the surface in a state of an oxide.

The element L dissolved in the lithium transition metal oxide and the element Me present in the outer layer portions of the lithium transition metal oxide particles may include the same type of element, and may not include the same type of element. Even when the element Me and the element L include the same type of element, the crystal structures and the like thereof are different, and these are therefore distinguished clearly. The element Me is not dissolved in the lithium transition metal oxide, and mainly constitutes an oxide having a different crystal structure from the lithium transition metal oxide in the outer layer portions of the lithium transition metal oxide particles. The element Me and the element L can be distinguished by various analytical methods including element mapping using EPMA (electron probe micro-analysis), the analysis of the chemical bond state using XPS (X-ray photoelectron spectroscopy), and SIMS (secondary ionization mass spectroscopy).

The amount of the element Me included in the active material particles is preferably 2% by mol or less based on the lithium transition metal oxide. When the amount of the element Me is more than 2% by mol, the outer layer portions of the lithium transition metal oxide particles become a resistance layer, the overvoltage increases, and the cycle characteristic therefore begins to decrease. Meanwhile, when the amount of the element Me is less than 0.1% by mol, the exposed portion of the lithium transition metal oxide increases, and the effect of suppressing a capacity decrease at the time of charge and storage may not therefore be obtained. The average particle size (D50) of the complex oxide particles is preferably, for example, 2 μm or more and 20 μm or less. When the average particle size (D50) is less than 2 μm and more than 20 μm, the packing density in the positive electrode active material layer may decrease, and the capacity may decrease as compared with when the above-mentioned range is satisfied. The average particle size (D50) of the positive electrode active material can be measured by laser diffractometry, for example, using MT3000II manufactured by MicrotracBEL Corp.

An example of a method for producing the complex oxide particles will be described.

First, an aqueous solution in which the raw material of the element Me are dissolved is mixed with a precursor (hydroxide) to prepare slurry, the pH is adjusted, and a compound including the Me is deposited. Then, the mixture is heat-treated at 500 to 750° C. to produce a precursor carrying the element Me. As long as the raw material of the element Me is a water-soluble salt, the raw material may be any salt. Examples of the raw material include nitrates, sulfates, acetates, carbonates, oxalates, silicates, phosphates, alkali metal salts, and ammonium salts, and especially ammonium salts are useful.

Then, a Li source is mixed into this precursor, the obtained mixture is calcined in an oxygen flow (oxygen concentration: 100% by volume), for example, at 500° C. for 4 hours and then fired at 730° C. for 24 hours. After cooling, the mixture is crushed to produce a positive electrode active material.

The positive electrode active material in which the oxide of element Me is present both on the surfaces of primary particles and on the surfaces of secondary particles can be synthesized thereby.

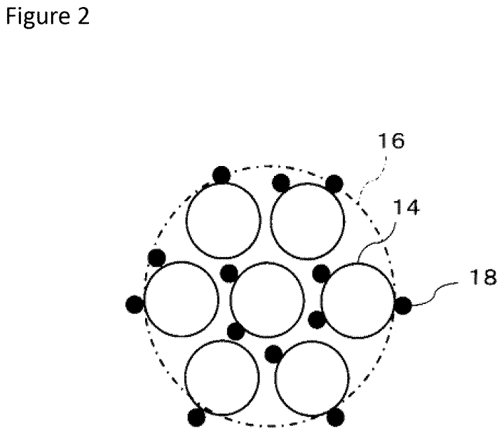

FIG. 2 is a schematic diagram of a positive electrode active material in the present embodiment. Primary particles 14 and a secondary particle 16 constituted by aggregation of the primary particles 14 are included, and an oxide 18 of the element Me (for example, W) is present both on the surfaces of the primary particles 14 and in the outer layer portion of the secondary particle 16.

The raw material of the element Me is mixed into the precursor before the firing step in this method, and alternatively, there is also a method in which the raw material of the element Me is mixed after the precursor is fired. However, the oxide of element Me is present only on the surfaces of the secondary particles in this case.

Examples of the conductive agent included in the positive electrode active material layer include carbon powders such as carbon black, acetylene black, ketjen black and graphite. These may be used singly or in combinations of two or more.

Examples of the binding agent included in the positive electrode active material layer include fluorine-containing polymers and rubber-based polymers. Examples of the fluorine-containing polymers include polytetrafluoroethylene (PTFE), polyvinylidene fluoride (PVDF), or modified product thereof. Examples of the rubber-based polymers include an ethylene-propylene-isoprene copolymer and an ethylene-propylene-butadiene copolymer. These may be used singly or in combinations of two or more.

The positive electrode of the present embodiment is obtained, for example, by forming a positive electrode active material layer on a positive electrode current collector by applying positive electrode mixture slurry including the positive electrode active material, the conductive agent, the binding agent and the like and drying the slurry, and rolling the positive electrode mixture layer.

[Negative Electrode]

The negative electrode constituting the secondary battery according to the present embodiment comprises, for example, a negative electrode current collector and a negative electrode active material layer formed on the negative electrode current collector. The negative electrode active material layer may be formed on one side of the negative electrode current collector, or may be formed on both sides. The negative electrode active material layer includes, for example, the negative electrode active material, a binding agent, and the like.

As the negative electrode current collector, foil of a metal which is stable in the potential range of the negative electrode, a film wherein the metal is disposed on the outer layer, or the like can be used. As the negative electrode current collector, a porous body such as a mesh body, a punching sheet, or an expanded metal of the metal may be used. As the material of the negative electrode current collector, copper, a copper alloy, aluminum, an aluminum alloy, stainless steel, nickel, or the like can be used. The thickness of the negative electrode current collector is, for example, preferably 3 μm or more and 50 μm or less in terms of a current collection property, mechanical strength, and the like.

For example, negative electrode mixture slurry including the negative electrode active material, the binding agent, and the dispersion medium is applied to the negative electrode current collector, the coating film is dried and then rolled, the negative electrode active material layer is formed on one side or both sides of the negative electrode current collector, and the negative electrode can be manufactured. The negative electrode active material layer may include optional components such as a conductive agent if required. Although the thickness of the negative electrode active material layer is not particularly limited, the thickness is, for example, 10 μm or more and 100 μm or less.

As long as the negative electrode active material is a material which enables occluding and emitting lithium ions, the negative electrode active material is not particularly limited. The material constituting the negative electrode active material may be a non-carbon-based material, may be a carbon material, or may be a combination thereof. Examples of the non-carbon-based material include a lithium metal and alloys including a lithium element as well as metallic compounds such as metal oxides, metal sulfides, and metal nitrides containing lithium. Examples of the alloys containing a lithium element include lithium-aluminum alloys, lithium-tin alloys, lithium-lead alloys, and lithium-silicon alloys. Examples of the metal oxides containing lithium include a metal oxide containing lithium and titanium, tantalum or niobium, and lithium titanate (Li₄Ti₅O₁₂ and the like) is preferable.

Examples of the carbon materials used as the negative electrode active material include graphite and hard carbon. Among others, graphite is preferable due to high capacity and small irreversible capacity. Graphite is a general term for a carbon material having graphite structure, and include natural graphite, artificial graphite, expanded graphite, and graphitized mesophase carbon particles. When graphite is used as the negative electrode active material, the surface of the negative electrode active material layer is preferably covered with a film to decrease the activity of the reductive decomposition of the aqueous electrolytic solution. These negative electrode active materials may be used alone or in combination of two or more.

As the binding agent included in the negative electrode active material layer, for example, a fluorine-containing polymer, a rubber-based polymer, or the like may be used in the same way as the positive electrode, and a styrene-butadiene copolymer (SBR) or a modified product thereof may be used. The content of the binding agent included in the negative electrode active material layer is preferably 0.1% by mass or more and 20% by mass or less, and more preferably 1% by mass or more and 5% by mass or less based on the total amount of the negative electrode active material. Examples of the thickener included in the negative electrode active material layer include carboxymethylcellulose (CMC) and polyethylene oxide (PEO). These may be used alone or in combination of two or more.

[Separator]

As long as the separator has functions of allowing lithium ions to permeate and electrically separating the positive electrode and the negative electrode, the separator is not particularly limited. As the separator, for example, a porous sheet or the like comprising a resin, an inorganic material, and the like is used. Specific examples of the porous sheet include fine porous thin films, woven fabrics and nonwoven fabrics. Examples of the resin material constituting the separator include olefin-based resins such as polyethylene and polypropylene; polyamides; polyamide-imides; and cellulose. Examples of the inorganic material constituting a separator include glass and ceramics such as borosilicate glass, silica, alumina, and titania. The separator may be a layered body having a cellulose fiber layer and a thermoplastic resin fiber layer of an olefin-based resin or the like. The separator may be a multilayer separator including a polyethylene layer and a polypropylene layer, and a separator wherein a material such as an aramid-based resin or a ceramic is applied to the surface of the separator may be used.

Although the secondary battery comprising the aqueous electrolytic solution was described in the above-mentioned embodiments, the aqueous electrolytic solution according to one example of the present embodiment may be used for a power storage device other than the secondary battery, and may be used, for example, for a capacitor. In this case, the capacitor comprises, for example, the aqueous electrolytic solution according to one example of the present embodiment and the two electrodes. The electrode materials constituting the electrodes can be used for the capacitor, and may be a material which enables occluding and emitting lithium ions. Examples thereof include materials such as a graphite-containing material such as natural graphite or artificial graphite and lithium titanate.

### EXAMPLES

Although Examples and Comparative Examples of the present disclosure will be described specifically hereinafter, the present disclosure is not limited to the following Examples.

### Example 1

A secondary battery was manufactured in the following procedure.

[Manufacturing of Positive Electrode]

in the synthesis process of a lithium transition metal oxide (LiNi_{0.82}Co_{0.15}Al_{0.03}O₂ (NCA)) as a positive electrode active material containing Li, Ni, Co, and Al, a complex oxide in which the surface was covered with a W oxide is produced through a step of mixing a precursor hydroxide [(Ni_{0.82}Co_{0.15}Al_{0.03})(OH)₂] obtained by a coprecipitation method with an ammonium paratungstate solution at a predetermined concentration to prepare a suspension, dropping dilute sulfuric acid thereinto with stirring, adjusting the pH to 8.5, then water-washing and drying the mixture to obtain a precursor carrying the W compound and a step of mixing LiOH with the precursor at a predetermined ratio and firing the mixture in an oxygen flow atmosphere at 750° C. for 10 hours. The amount of the W oxide was adjusted to 0.15% by mol based on the total amount of Ni, Co, and Al.

It was confirmed by SEM observation that the complex oxide included primary particles and secondary particles formed by aggregation of the primary particles, and the W oxide was present on the surfaces of the primary particles and in the outer layer portions of the secondary particles.

Into this complex oxide, acetylene black (AB) as a conductive agent and polyvinylidene fluoride (PVdF) as a binder were mixed at a mass ratio of NCA:AB:PVdF=100:1:0.9, N-methyl-2-pyrrolidone (NMP) was further added in a suitable amount, and the mixture was stirred to prepare positive electrode slurry. Subsequently, the obtained positive electrode slurry was applied to one side of aluminum foil (positive electrode current collector) and then dried, and the coating film of the positive electrode mixture was rolled using a roller to manufacture the positive electrode of Example 1.

[Manufacturing of Negative Electrode]

Graphite as a negative electrode active material, a styrene-butadiene copolymer (SBR) as a binding agent, and carboxymethyl cellulose (CMC) as a thickening agent were mixed so that the mass ratio was 100:1:1 water was added to prepare negative electrode mixture slurry. Subsequently, the negative electrode mixture slurry was applied to both sides of a negative electrode current collector comprising copper foil, and this was dried and then rolled with the rolling roller to manufacture a negative electrode in which negative electrode active material layers were formed on both sides of the negative electrode current collector.

[Production of Aqueous Electrolytic Solution]

LiN(SO₂CF₃)₂, LiN(SO₂C₂F₅)₂, LiOH.H₂O, and water (ultrapure water) were mixed at a molar ratio of 0.7:0.3:0.034:1.923.

[Manufacturing of Secondary Battery]

The above-mentioned positive electrode and negative electrode were wound through a separator to manufacture an electrode assembly, the electrode assembly was stored with the above-mentioned aqueous electrolyte in a bottomed cylindrical battery case, and the opening of the battery case was sealed with a gasket and a sealing assembly. This was used as the secondary battery of Example 1.

### Comparative Example 1

In the process for producing the positive electrode active material, a positive electrode was manufactured by the same method as in Example 1 except that the step of making the precursor carry the W compound was omitted. A secondary battery was manufactured using the manufactured positive electrode and evaluated in the same way as in Example 1. That is, in Comparative Example 1, a lithium transition metal oxide (LiNi_{0.87}Co_{0.15}Al_{0.03}O₂ (NCA)) is used as the positive electrode.

[Evaluation of Stability at Time of Charge and Storage]

Each battery was charged at a constant current of 0.1 C until the closed circuit voltage of the battery reached 2.75 V The battery was then stored at 25° C. for 72 hours. After storage, the battery was discharged at a constant current of 0.1 C until the closed circuit voltage of the battery reached 1.45 V The change in the discharge capacity of the battery at this time was determined as a capacity residual rate (%), and the amount of change in the open circuit voltage of the battery during charge and storage (V) was also determined. That is, the capacity residual rate is:

Capacity residual rate (%)=(discharge capacity at time of charge and storage test)/(discharge capacity before charge and storage test)×100.

The charge and storage test was performed under the condition of 25° C. The capacity residual rate and the amount of change in open circuit voltage (V) were considered as the evaluation of the stability at the time of charge and storage.

Table 1 shows the evaluation results.

TABLE 1

| | | | Storage test result | |
|---|---|---|---|---|
| | | | (at 25° C. for 3 days) | |
| | Positive electrode material | | Capacity | Voltage |
| | Li/Me | Surface | residual rate | decrease |
| | ratio | oxide | % | V |
| Example 1 | 1.002 | Present | 82.5 | −0.179 |
| Comparative | 1.003 | Absent | 80.2 | −0.219 |
| Example 1 | | | | |

It can be said that as the capacity residual rate becomes higher, and the amount of change in open-circuit voltage becomes smaller, the battery is a highly stable battery.

As shown in Table 1, the secondary battery of Example 1 enabled suppressing the capacity residual rate at the time of charge and storage and a voltage decrease as compared with the secondary battery of Comparative Example 1. That is, the charge and storage stability of the secondary battery of Example 1 was improved.

The negative electrodes of the manufactured batteries are lithium titanate, and are a material wherein the potentials of the negative electrodes hardly fluctuate. The suppression of a decrease in open circuit voltage means the suppression of a decrease in the potential of a positive electrode from this. Therefore, it is found that the potential decrease of the positive electrode could be suppressed, and the charge and storage stability of the battery could be improved by covering the positive electrode active material with the W oxide. This is because when the W oxide is present on the surface of the lithium transition metal oxide, the oxygen overvoltage of water is increased, and the oxidative decomposition reaction of the aqueous electrolytic solution which occurs on the surface of the positive electrode active material as well as an increase in the pH of the electrolytic solution and the elution of the transition metals accompanying it are suppressed. It is considered that high discharge capacity and voltage could therefore be maintained also after the charge and storage test.

Even though the oxide present on the surface of the lithium transition metal oxide is an oxide other than the W oxide, the same effect is exhibited. It is because when, for example, oxides of B, Si, P, Ti, V, Mn, Al, Mg, Ca, Zr, Nb, Ta, In, Mo, and Sn which is present stably in the charge and discharge reactions of the secondary battery are present on the surface of the positive electrode active material, the oxygen overvoltage of water is increased, and the forward reactions of the secondary battery are not adversely affected.

### REFERENCE SIGNS LIST

10 positive electrode active material
14 primary particle
16 secondary particle.

1. A positive electrode active material for a secondary battery having an electrolytic solution prepared by dissolving a lithium salt in water, wherein
the positive electrode active material includes a lithium transition metal oxide represented by the general formula LiₓM_{1-y}L_{y}O₂, wherein 0.9≤x≤1.1, 0≤y<0.6, an element M is at least one selected from the group consisting of Ni and Co, and an element L is at least one selected from the group consisting of alkaline-earth elements, transition metal elements other than Ni and Co, rare earth elements, Group IIIb elements, and Group IVb elements, and
the positive electrode active material is a complex oxide having an oxide of an element Me, which is at least one selected from the group consisting of B, Si, P, Ti, V, Mn, Al, Mg, Ca, Zr, W, Nb, Ta, In, Mo, and Sn, in an outer layer portion of the lithium transition metal oxide.

2. The positive electrode active material for a secondary battery according to claim 1, wherein
the complex oxide includes primary particles and secondary particles formed by aggregation of the primary particles, and
the oxide of Me is present on surfaces of the primary particles and in outer layer portions of the secondary particles.

3. The positive electrode active material for a secondary battery according to claim 1, wherein
the element Me includes at least one element selected from the group consisting of B, Si, P, Ti, V, Nb, and W.

4. The positive electrode active material for a secondary battery according to claim 3, wherein
the element Me is W.

5. The positive electrode active material for a secondary battery according to claim 1, wherein
x in the general formula satisfies 0.95<x<1.02.

6. The positive electrode active material for a secondary battery according to claim 1, wherein
a pH of the electrolytic solution is more than 10.

7. The positive electrode active material for a secondary battery according to claim 1, wherein
a molar ratio of water to the lithium salt of the electrolytic solution is less than 4.

8. A secondary battery, comprising:
a positive electrode containing the positive electrode active material for a secondary battery according to claim 1;
a negative electrode containing a negative electrode active material; and
an electrolytic solution prepared by dissolving a lithium salt in water.
